(19) United States
(12) Patent Application Publication
(10) Pub. No.: US 2024/0384811 A1
(43) Pub. Date: Nov. 21, 2024

(54) ELECTROMAGNETIC VALVE FOR A FUEL CELL SYSTEM

(71) Applicant: ECO Holding 1 GmbH, Marktheidenfeld (DE)

(72) Inventors: Dietmar Schulze, Muenzenberg (DE); Andreas Knecht, Tuebingen (DE); André Selke, Lohr (DE)

(21) Appl. No.: 18/197,129

(22) Filed: May 15, 2023

(30) Foreign Application Priority Data
May 16, 2022 (DE) DE102022112199.2

(51) Int. Cl. F16K 31/06; H01M 8/04089; H01M 8/04746

(52) U.S. Cl. CPC F16K 31/0675; H01M 8/04089; H01M 8/04753; H01M 2008/1095

(57) ABSTRACT

An electromagnetic valve for an anode supply of a fuel cell system wherein the electromagnetic valve is configured as a purge or drain valve, the electromagnetic valve including a magnet coil that electromagnetically actuates the electromagnetic valve,
wherein the magnet coil is a heating element and includes a coil winding which includes at least one additional electrical contact besides electrical end contacts.

### RELATED APPLICATIONS

This application claims priority from and incorporates by reference German Patent Application DE 10 2022 112 199.2 filed on May 16, 2022.

### FIELD OF THE INVENTION

The invention relates to an electromagnetic valve for an anode supply of a fuel cell system wherein the electromagnetic valve is configured as a purge or drain valve and a fuel cell system including the valve.

### BACKGROUND OF THE INVENTION

Fuel cell systems with an anode supply and a cathode supply are well known in the art. Fuel cell systems use a chemical reaction of a fuel with oxygen to form water and generate electrical energy. In order to supply a fuel cell stack of the fuel cell system with operating agents, an anode supply is provided to feed and exhaust the anode operating agent, e.g. hydrogen, a cathode supply to feed and exhaust the cathode operating agent, e.g. air and a coolant cycle. The anode supply and the cathode supply respectively include a supply conduit to feed the operating agent and an exhaust gas conduit. The anode supply furthermore includes a recirculation conduit configured to reintroduce hydrogen included in the anode exhaust of the fuel cell stack back into the fuel cell stack.

The anode exhaust gas conduit typically includes a water precipitator with a downstream drain valve configured to drain product water produced in the fuel cell reaction and a purge valve configured to vent the anode gas, mostly nitrogen.

At low ambient temperatures, there is a risk for water included in the valve channels to freeze so that the valves become iced. This can lead to a malfunction and damaging of the fuel cell system.

Thus, valves are known in the art that include electrical heating elements proximal to the valves or in the valves.

It is also known to use the coil of the magnet valve as a heating element.

### BRIEF SUMMARY OF THE INVENTION

As matter of principle a quick heating of the valve channels is desirable so that it is an object of the invention to provide an electromagnetic valve as a purge or drain valve of a fuel cell system, wherein the electromagnetic valve facilitates a quicker heating of the valve channels compared to known electromagnetic valves. It is another object of the invention to provide a fuel cell system with valves that are heatable quickly.

The object is achieved by an electromagnetic valve for an anode supply of a fuel cell system wherein the electromagnetic valve is configured as a purge or drain valve, the electromagnetic valve including a magnet coil configured to electromagnetically actuate the electromagnetic valve, wherein the magnet coil is configured as a heating element and includes a coil winding which includes at least one additional electrical contact besides electrical end contacts.

The electromagnetic valve according to the invention for an anode supply of a fuel cell system is configured as a purge or drain valve. It includes a magnet coil configured to electromagnetically actuate the valve wherein the magnet coil is configured as a heating element and includes a coil winding which includes electrical contacts at ends of the coil winding and at least one additional electrical contact.

The additional contact facilitates a multiplication of the achievable heating power without requiring additional material or installation space.

According to an advantageous embodiment of the invention the additional electrical contact of the magnet coil is provided in a center of the magnet coil. Thus, the heating power can be quadrupled.

The heating power can be increased even further by the magnet coil including more than one additional contact.

According to an advantageous embodiment a valve body of the valve can be in direct surface contact with iron parts of the magnet coil.

When a valve body of the valve is made from synthetic material, metal parts can be arranged as inserts in the synthetic material in order to improve heat conductivity.

The object is also achieved by a fuel cell system including at least one fuel cell stack; a cathode supply; an anode supply; and the electromagnetic valve recited supra arranged in the anode supply.

Additional advantageous embodiments and feature combinations according to the invention can be derived from the subsequent detailed description and from the patent claims.

### BRIEF DESCRIPTION OF THE DRAWINGS

The invention is now described based on an advantageous embodiment with reference to drawing figures, wherein:

FIG. 1 illustrates a schematic representation of a fuel cell system;

FIG. 2 illustrates the contacts of a schematic coil winding of the electromagnetic valve according to the invention during normal valve actuation; and

FIG. 3 illustrates the contacts of the schematically illustrated coil winding of the electromagnetic valve according to the invention during heating operation.

### DETAILED DESCRIPTION OF THE INVENTION

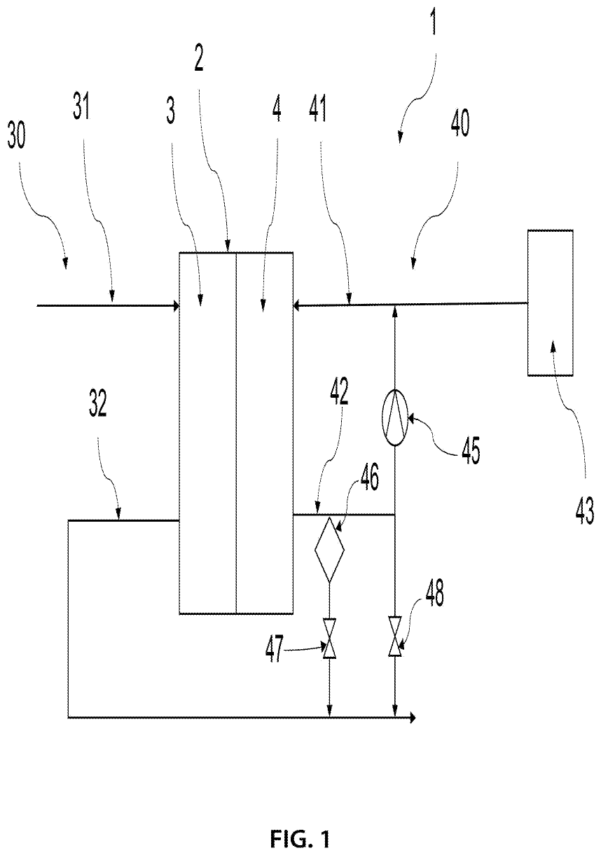

FIG. 1 shows a schematic representation of a known fuel cell system 1 of a vehicle, in particular an electric vehicle, including an electric traction motor which is supplied with electric energy by the fuel cell system 1.

The fuel cell system 1 includes a fuel cell stack 2, which can be typically configured as a stack of PEM fuel cells. A cathode supply 30 is associated with a common cathode cavity 3 for feeding and exhausting the cathode operating agent, e.g. air and an anode supply 40 is associated with a common anode cavity 4 for feeding and exhausting the anode operating agent, e.g. hydrogen.

The cathode supply 30 includes a cathode supply conduit 31, which feeds air pulled from ambient to the common cathode cavity 3 of the fuel cell stack 2. A cathode exhaust gas conduit 32 exhausts cathode exhaust gas from the cathode cavity 3. The cathode exhaust gas is optionally fed to an exhaust gas system.

The anode supply 40 includes an anode supply conduit 41 by which the anode operating agent, in particular hydrogen is provided from a hydrogen tank 43 to the anode cavity 4. The anode supply conduit 41 typically includes additional components e.g. a tank valve, a dosing valve and a cut off valve. An anode exhaust gas conduit 42 exhausts anode exhaust gas from the anode cavity 4. The anode supply 40 additionally includes a recirculation conduit 44 configured to feed hydrogen included in the anode exhaust gas of the fuel cell stack 2 by a recirculation device 45, e.g. a recirculation blower back to the fuel cell stack 2.

The anode exhaust conduit 41 additionally includes a water precipitator 46 with a downstream drain valve 47 configured to drain product water generated by the fuel cell reaction and a purge valve configured to vent the anode gasses, mostly nitrogen.

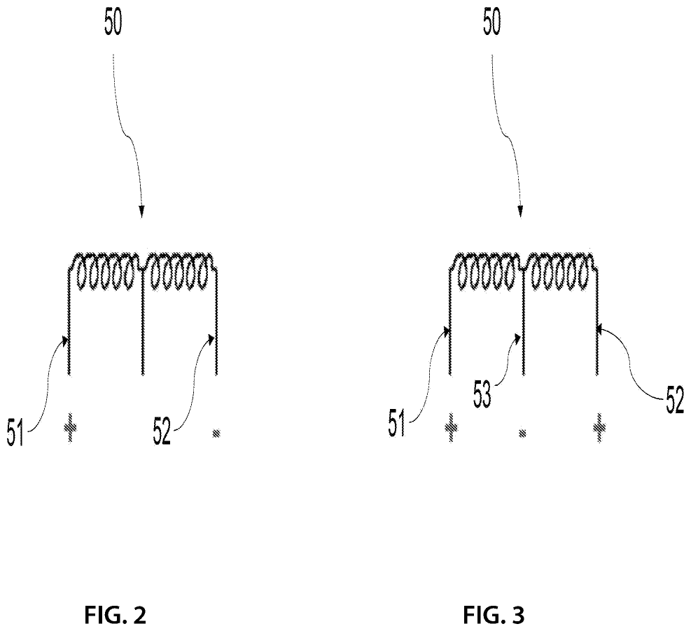

The drain and the purge valve 47, 48 are configured as electromagnetic valves and respectively include a magnet coil for electromagnetic actuation of the valve. In order to facilitate a quick heating of the valve channels at low ambient temperatures and thus a functioning of the fuel cell system the magnet coil 50 schematically illustrated in FIGS. 2 and 3 includes an additional electrical contact 53 besides the electrical end contacts 51, 52. The additional electrical contact is advantageously provided in a center of the magnet coil 50. Put differently, the coil winding includes an additional electrical contact 53 (center contact) advantageously approximately in a center of a coil wire length or approximately after half the windings, so that three electrical contacts 51, 52, 53 are provided instead of only two electrical contacts.

For normal valve operation an on board voltage of e.g. 12 volts is applied to both ends of the coil wire as illustrated in FIG. 2.

For the heating function illustrated in FIG. 3, the two end contacts receive the same potential and the center contact receives the other potential. Thus, the on-board voltage impacts two half coils switched in parallel which then each have half the resistance of the original magnet coil.

When the coil has a resistance of e.g. 6.8 Ohm, each of the partial windings has a resistance of 3.4 Ohm during the heating function. Thus the current achievable in each partial winding is 3.5 A and the power is 42 W so that both partial windings can achieve 84 W in combination, whereas valve operation would only achieve a heating power of 21 W. The center contact facilitates quadrupling the achievable heating power without requiring additional materials like iron and copper and installation space.

The magnet coil 50 according to the invention can be part of a coil family, this means it can be produced in the same injection molding tool and with the same stamped iron parts like the other coil types of the family that do not require the heating function since the valve properties are unchanged during normal operation.

The magnetic flux generated by the two partial coils can cancel itself out almost completely in an advantageous configuration, this means the heating does not generate any undefined valve opening caused by partial deicing.

In order to further decrease heating power, the coil winding can be divided into even more parts according to an advantageous embodiment of the invention.

In order to conduct heat efficiently from the magnet coil 50 to the valve body and its channels, the valve body can have a direct surface contact with iron components of the magnet coil 50.

When the valve body is made from synthetic material, metal parts can be arranged as inserts in the synthetic material in order to improve heat conductivity.

All features described and shown in the individual embodiments of the invention can be used in various combinations when practicing the invention in order to achieve their advantageous effects. The spirit and scope of the invention is defined exclusively by the patent claims and is not limited by the features provided in the description or shown in the drawing figures.

What is claimed is:

1. An electromagnetic valve for an anode supply of a fuel cell system wherein the electromagnetic valve is configured as a purge or drain valve, the electromagnetic valve comprising:
a magnet coil that electromagnetically actuates the electromagnetic valve,
wherein the magnet coil is a heating element and includes a coil winding which includes at least one additional electrical contact besides electrical end contacts.

2. The electromagnetic valve according to claim 1, wherein the additional electrical contact of the magnet coil is centrally provided in the magnet coil.

3. The electromagnetic valve according to claim 1, wherein the magnet coil includes more than one additional contact.

4. The electromagnetic valve according to claim 1, wherein a valve body of the electromagnetic valve is in direct surface contact with iron components of the magnet coil.

5. The electromagnetic valve according to claim 1,
wherein a valve body of the valve is made from a synthetic material, and
wherein metal insert parts are arranged in the synthetic material that improve heat conductivity.

6. A fuel cell system, comprising:
at least one fuel cell stack;
a cathode supply;
an anode supply; and
the electromagnetic valve according to claim 1 arranged in the anode supply.
